(19) United States
(12) Patent Application Publication
(10) Pub. No.: US 2022/0186612 A1
(43) Pub. Date: Jun. 16, 2022

(54) Apparatus And Methods For Distributed Brillouin Frequency Sensing Offshore

(71) Applicant: Halliburton Energy Services, Inc., Houston, TX (US)

(72) Inventors: John Laureto Maida, JR., Houston, TX (US); Daniel Joshua Stark, Houston, TX (US); Glenn Andrew Wilson, Houston, TX (US); Andreas Ellmauthaler, Houston, TX (US); Michel Joseph LeBlanc, Houston, TX (US); Mikko K. Jaaskelainen, Houston, TX (US)

(73) Assignee: Halliburton Energy Services, Inc., Houston, TX (US)

(21) Appl. No.: 17/518,240

(22) Filed: Nov. 3, 2021

Related U.S. Application Data
(60) Provisional application No. 63/124,960, filed on Dec. 14, 2020.

(51) Int. Cl. E21B 47/135; G02B 6/36

(52) U.S. Cl. CPC E21B 47/135; G01B 11/16; G02B 6/3604

(57) ABSTRACT

A distributed fiber sensing system and method of use. The system may comprise an interrogator configured to receive a Brillouin backscattered light from a first sensing region and a second sensing region, a first fiber optic cable optically connected to the interrogator, a proximal circulator, and a distal circulator, and a second fiber optic cable optically connected to the interrogator, the proximal circulator, and the distal circulator. The system may further comprise a downhole fiber optically connected to the first fiber optic cable and the second fiber optic cable and wherein the first sensing region and the second sensing region are disposed on the downhole fiber. The method may comprise generating and launching a light pulse from an interrogator and through a first fiber optic cable to a downhole fiber and receiving a Brillouin backscattered light from a first sensing region and a second sensing region.

### BACKGROUND

Boreholes drilled into subterranean formations may enable recovery of desirable fluids (e.g., hydrocarbons), or geological storage of other fluids (e.g., carbon dioxide), using a number of different techniques. A number of systems and techniques may be employed in subterranean operations to determine borehole and/or formation properties. For example, distributed fiber optic sensing, such as Distributed Temperature Sensing (DTS) and/or Distributed Acoustic Sensing (DAS) along with a fiber optic system may be utilized together to determine borehole and/or formation properties. Distributed fiber optic sensing is a cost-effective method of obtaining real-time, high-resolution, highly accurate temperature, strain (static or dynamic, including acoustic) data along the entire wellbore. In examples, discrete sensors, e.g., for sensing pressure, temperature, and/or strain, may be deployed in conjunction with the fiber optic cable. Additionally, distributed fiber optic sensing may eliminate downhole electronic complexity by shifting all electro-optical complexity to the surface within the interrogator unit. Fiber optic cables may be permanently deployed in a wellbore via single- or dual-trip completion strings, behind casing, on tubing, or in pumped down installations; or temporally via coiled tubing, wireline, slickline, or disposable cables.

Distributed fiber optic sensing can be enabled by continuously sensing along the length of the fiber, and effectively assigning discrete measurements to a position along the length of the fiber via optical time-domain reflectometry (OTDR). That is, knowing the velocity of light in fiber, and by measuring the time it takes the backscattered light to return to the detector inside the interrogator, it is possible to assign a measurement and distance along the fiber. In alternative, embodiment, optical frequency-domain reflectometry (OFDR) may be practiced.

Distributed temperature sensing (DTS) based on Raman backscattering (Raman DTS) has been practiced for permanent installations in dry-tree wells to enable interventionless, time-lapse temperature monitoring for well integrity, cap rock integrity, flow assurance, and multiphase flow. Marinization of the Raman DTS interrogator (that is, packaging it for deployment on a structure residing on the sea floor) for sensing a subsea well introduces significant complexity to the subsea production system, and doesn't readily permit DTS interrogator hardware upgrades. It is preferable to maintain any interrogator (DTS, DAS, etc.) on the topside facility, and sense through the subsea infrastructure. However, such a subsea operation then requires optical engineering solutions to compensate for insertion losses accumulated through long (˜5 to 100+ km) lengths of subsea transmission fiber, up to 10 km of in-well subsurface fiber, and multiple wet- and dry-mate optical connectors, splices, and optical feedthrough systems (OFS).

Topside-deployed Raman DTS measurements are not currently feasible for sensing subsea wells. The two main problems are the available optical power budget, and the wavelength dependency of the measured signals required to calculate accurate temperature profiles. Specifically, Raman DTS systems are limited in optical power budgets due to the physics of Raman scattering and suffer significantly in subsea applications due to the optical attenuation of the multiple wet- and dry-mate optical connectors, splices, optical feedthrough systems (OFSs) and downhole fibers. The second problem is the wavelength dependency of the measured Stokes and anti-Stokes intensities as the temperature profile is calculated as a function of the ratios of these signals. The optical attenuation across connectors and splice may, in many instances, have a wavelength dependence that varies with environmental temperature and/or directionality of the propagation of the optical signals. Any wavelength dependent attenuation as the signals pass through connectors, splices and OFSs will generate step changes in the measured temperature profile. Calibration may be used to mitigate some of these effects, but it is well known that components/connections change characteristics over time, and a system would therefore periodically require re-calibration/re-baselining with associated changes in the temperature profile and data interpretation. These problems imply that topside deployment of existing Raman DTS is not feasible in order to achieve accurate and stable temperature measurements required for subsea well and reservoir diagnostics.

### BRIEF DESCRIPTION OF THE DRAWINGS

For a detailed description of the preferred examples of the disclosure, reference will now be made to the accompanying drawings in which:

FIG. 1 illustrate an example of a well measurement system in a subsea environment;

FIG. 2 illustrates an example of a DAS system;

FIG. 3 illustrate an example of a DAS system with lead lines;

FIG. 4 illustrates a schematic of another example DAS system;

FIG. 5 illustrates an example of a remote circulator arrangement;

FIG. 6 illustrates a graph for determining time for a light pulse to travel in a fiber optic cable;

FIG. 7 illustrates another graph for determining time for a light pulse to travel in a fiber optic cable;

FIG. 8 illustrates an example of a remote circulator arrangement;

FIG. 9 illustrates another graph for determining time for a light pulse to travel in a fiber optic cable;

FIG. 10A illustrates a graph of sensing regions in the DTS system;

FIG. 10B illustrates a graph with an active proximal circulator using an optimized DAS sampling frequency of 12.5 kHz;

FIG. 10C illustrates a graph with a passive proximal circulator using an optimized DAS sampling frequency of 12.5 kHz;

FIG. 11 illustrates a graph of optimized sampling frequencies in the DAS system;

FIG. 12 illustrates an example of a workflow for optimizing the sampling frequencies of the DAS system;

FIG. 13 illustrates another example of the DAS system;

FIG. 14 illustrates another example of the DAS system;

FIG. 15 illustrates another example of the DAS system;

FIG. 16 illustrates an example of a DTS system with a Brillouin Optical Time Domain Reflectometry (BOTDR) as an interrogator;

FIG. 17 illustrates another example of a DTS with a BOTDR as an interrogator;

FIG. 18 illustrates another example of a DTS with a BOTDR as an interrogator;

FIG. 19 illustrates another example of a DTS with a BOTDR as an interrogator;

FIG. 20A-20D illustrates examples of a downhole fiber deployed in a wellbore; and

FIG. 21 illustrates an example of the well measurement system in a land-based operation.

### DETAILED DESCRIPTION

The present disclosure relates generally to a system and method for distributed fiber optic sensing system, which may include Distributed Acoustic Sensing (DAS), Distributed Temperature Sensing (DTS) and Distributed Brillouin-Frequency Sensing (DBFS), the latter which may be used in the extraction of distributed strain, temperature, or pressure or a combination thereof. Subsea operations may present optical challenges which may relate to the quality of the overall signal in distributed fiber optic sensing systems with a longer fiber optic transmission and sensing cables. The overall signal may be critical since the end of the fiber contains the interval of interest (i.e., the well and reservoir sections).

To prevent a drop in signal-to-noise (SNR) and signal quality and fidelity, the distributed fiber optic sensing system described below may increase the returned signal strength with given pulse power, decrease the noise floor of the receiving optics to detect weaker power pulses, maintain the pulse power as high as possible as it propagates down the fiber, increase the number of light pulses that can be launched into the fiber per second, and/or increase the maximum pulse power that can be used for given fiber length.

To take distributed measurements in subsea installations, systems and methods are discussed below that teach the ability to sense and record or log real-time measurements of the Brillouin frequency along sensing fiber regions that can then interpreted in terms of strain, temperature, or pressure using Brillouin Optical Time Domain Reflectometry (BOTDR) by itself or in conjunction with DAS or Raman-based DTS systems. For the purpose of this disclosure, BOTDR and DBFS shall be considered synonyms. The instrumentation and process improvements over current technology include systems and methods to employ Brillouin backscatter-based measurement technology instead of Raman backscatter-based technology as BOTDR has at least a 10 dB greater optical budget than Raman techniques. Additionally, utilizing BOTDR allows for systems and methods to be used on the same fiber installations that currently utilize distributed acoustic sensing (DAS) so that existing, as well as new, wells may be interrogated. These methods and systems improve temperature profile accuracy over the wellbore length at any location within a wellbore. As discussed in greater detail, the DAS and BOTDR systems may be interchangeable and utilize the same fiber optic cables, circulators, umbilical line, downhole fiber, sensing areas, and/or the like. Changing the components of the interrogator may shift the overall system from DAS to BOTDR, or vice-versa.

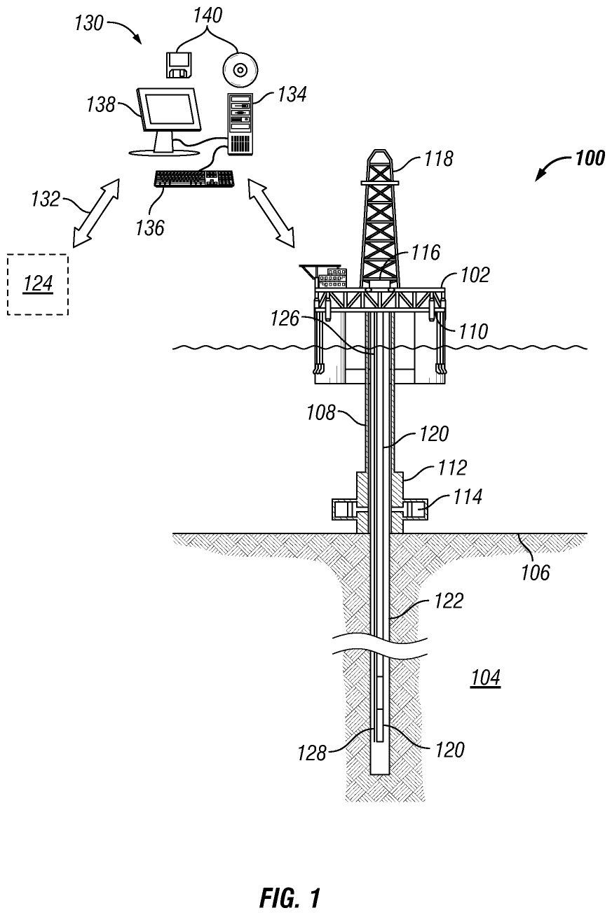

FIG. 1 illustrates an example of a well system 100 that may employ the principles of the present disclosure. More particularly, well system 100 may include a floating vessel 102 centered over a subterranean hydrocarbon bearing formation 104 located below a sea floor 106. As illustrated, floating vessel 102 is depicted as an offshore, semi-submersible oil and gas drilling platform, but could alternatively include any other type of floating vessel such as, but not limited to, a drill ship, a pipe-laying ship, a tension-leg platforms (TLPs), a “spar” platform, a production platform, a floating production, storage, and offloading (FPSO) vessel, a floating production and unit (FPU), and/or the like. Additionally, the methods and systems described below may also be utilized on land-based drilling operations. A subsea conduit or riser 108 extends from a deck 110 of floating vessel 102 to a wellhead installation 112 that may include one or more blowout preventers 114. In examples, riser 108 may also be referred to as a flexible riser, flowline, umbilical, and/or the like. Floating vessel 102 has a hoisting apparatus 116 and a derrick 118 for raising and lowering tubular lengths of drill pipe, such as a tubular 120. In examples, tubular 120 may be a drill string, casing, production pipe, and/or the like.

A wellbore 122 extends through the various earth strata toward the subterranean hydrocarbon bearing formation 104 and tubular 120 may be extended within wellbore 122. Even though FIG. 1 depicts a vertical wellbore 122, it should be understood by those skilled in the art that the methods and systems described are equally well suited for use in horizontal or deviated wellbores. During drilling operations, the distal end of tubular 120, for example a drill sting, may include a bottom hole assembly (BHA) that includes a drill bit and a downhole drilling motor, also referred to as a positive displacement motor (“PDM”) or “mud motor.” During production operations, tubular 120 may include a DAS system. The DAS system may be inclusive of an interrogator 124, umbilical line 126, and downhole fiber 128.

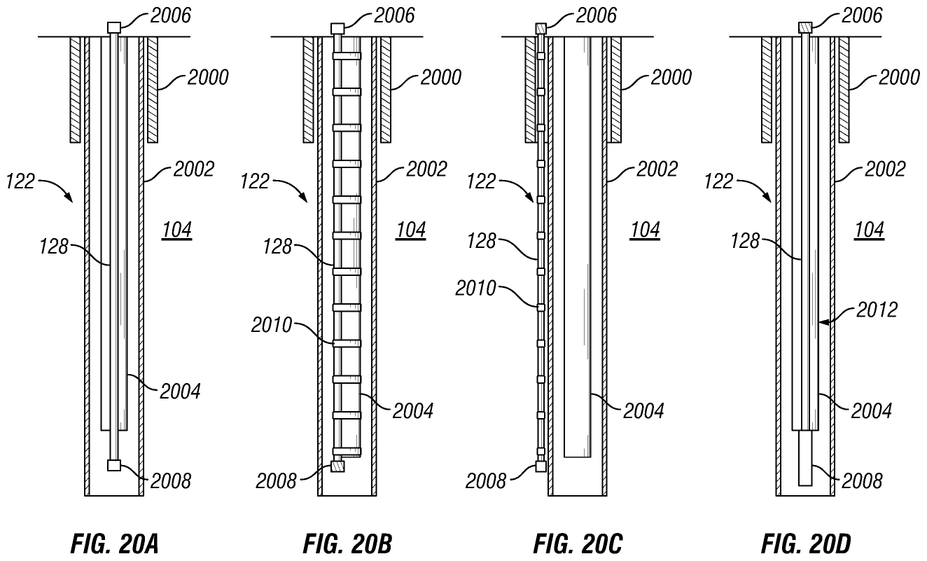

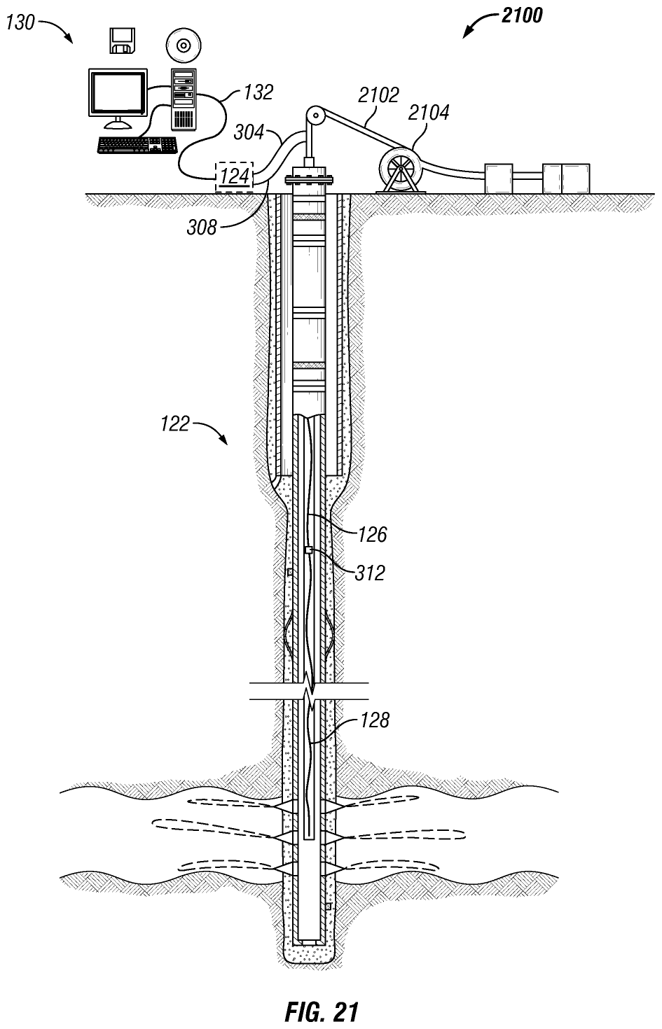

Downhole fiber 128 may be permanently deployed in a wellbore via single- or dual-trip completion strings, behind casing, on tubing, or in pumped down installations. In examples, downhole fiber 128 may be temporarily deployed via coiled tubing, wireline, slickline, or disposable cables. FIGS. 20A-20D illustrate examples of different types of deployment of downhole fiber 128 in wellbore 122 (e.g., referring to FIG. 1). As illustrated in FIG. 20A, wellbore 122 deployed in formation 104 may include surface casing 2000 in which production casing 2002 may be deployed. Additionally, production tubing 2004 may be deployed within production casing 2002. In this example, downhole fiber 128 may be temporarily deployed in a wireline system in which a bottom hole gauge 2008 is connected to the distal end of downhole fiber 128. Further illustrated, downhole fiber 128 may be coupled to a fiber connection 2006. Without limitation, fiber connection 2006 may attach downhole fiber 128 to umbilical line 126 (e.g., referring to FIG. 1). Fiber connection 2006 may operate with an optical feedthrough system (itself comprising a series of wet- and dry-mate optical connectors) in the wellhead that optically couples downhole fiber 128 from the tubing hanger to umbilical line 126 on the wellhead instrument panel. Umbilical line 126 may include at least one optical flying lead, optical distribution system(s), umbilical termination unit(s), static and/or dynamic umbilical lines, and transmission fibers encapsulated in flying leads, flow lines, rigid risers, flexible risers, and/or one or more umbilical lines. This may allow for umbilical line 126 to connect and disconnect from downhole fiber 128 while preserving optical continuity between the umbilical line 126 and the downhole fiber 128.

FIG. 20B illustrates an example of permanent deployment of downhole fiber 128. As illustrated in wellbore 122 deployed in formation 104 may include surface casing 2000 in which production casing 2002 may be deployed. Additionally, production tubing 2004 may be deployed within production casing 2002. In examples, downhole fiber 128 is attached to the outside of production tubing 2004 by one or more cross-coupling protectors 2010. Without limitation, cross-coupling protectors 2010 may be evenly spaced and may be disposed on every other joint of production tubing 2004. Further illustrated, downhole fiber 128 may be coupled to fiber connection 2006 at one end and bottom hole gauge 2008 at the opposite end.

FIG. 20C illustrates an example of permanent deployment of downhole fiber 128. As illustrated in wellbore 122 deployed in formation 104 may include surface casing 2000 in which production casing 2002 may be deployed. Additionally, production tubing 2004 may be deployed within production casing 2002. In examples, downhole fiber 128 is attached to the outside of production casing 2002 by one or more cross-coupling protectors 2010. Without limitation, cross-coupling protectors 2010 may be evenly spaced and may be disposed on every other joint of production tubing 2004. Further illustrated, downhole fiber 128 may be coupled to fiber connection 2006 at one end and bottom hole gauge 2008 at the opposite end.

FIG. 20D illustrates an example of a coiled tubing operation in which downhole fiber 128 may be deployed temporarily. As illustrated in FIG. 20D, wellbore 122 deployed in formation 104 may include surface casing 2000 in which production casing 2002 may be deployed. Additionally, coiled tubing 2012 may be deployed within production casing 2002. In this example, downhole fiber 128 may be temporarily deployed in a coiled tubing system in which a bottom hole gauge 2008 is connected to the distal end of downhole fiber. Further illustrated, downhole fiber 128 may be attached to coiled tubing 2012, which may move downhole fiber 128 through production casing 2002. Further illustrated, downhole fiber 128 may be coupled to fiber connection 2006 at one end and bottom hole gauge 2008 at the opposite end. During operations, downhole fiber 128 may be used to take measurements within wellbore 122, which may be transmitted to the surface and/or interrogator 124 (e.g., referring to FIG. 1) in the DAS system.

Additionally, within the DAS system, interrogator 124 may be connected to an information handling system 130 through connection 132, which may be wired and/or wireless. It should be noted that both information handling system 130 and interrogator 124 are disposed on floating vessel 102. Both systems and methods of the present disclosure may be implemented, at least in part, with information handling system 130. Information handling system 130 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 130 may be a processing unit 134, a network storage device, or any other suitable device and may vary in size, shape, performance, functionality, and price. Information handling system 130 may include random access memory (RAM), one or more processing resources such as a central processing unit (CPU) or hardware or software control logic, ROM, and/or other types of nonvolatile memory. Additional components of the information handling system 130 may include one or more disk drives, one or more network ports for communication with external devices as well as an input device 136 (e.g., keyboard, mouse, etc.) and video display 138. Information handling system 130 may also include one or more buses operable to transmit communications between the various hardware components.

Alternatively, systems and methods of the present disclosure may be implemented, at least in part, with non-transitory computer-readable media 140. Non-transitory computer-readable media 140 may include any instrumentality or aggregation of instrumentalities that may retain data and/or instructions for a period of time. Non-transitory computer-readable media 140 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such as wires, optical fibers, microwaves, radio waves, and other electromagnetic and/or optical carriers; and/or any combination of the foregoing.

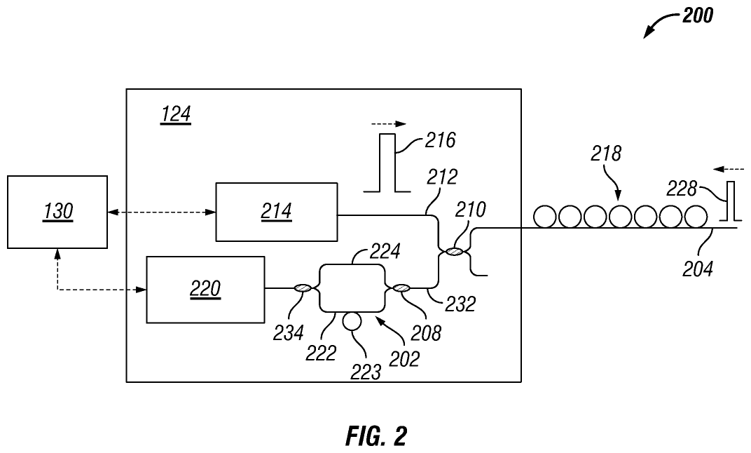

Production operations in a subsea environment present optical challenges for DAS. For example, a maximum pulse power that may be used in DAS is approximately inversely proportional to fiber length due to optical non-linearities in the fiber. Therefore, the quality of the overall signal is poorer with a longer fiber than a shorter fiber. This may impact any operation that may utilize the DAS since the distal end of the fiber actually contains the interval of interest (i.e., the reservoir) in which downhole fiber 128 may be deployed. The interval of interest may include wellbore 122 and formation 104. For pulsed DAS systems such as the one exemplified in FIG. 2, an additional challenge is the drop-in signal to noise ratio (SNR) and spectral bandwidth associated with the decrease in the number of light pulses that may be launched into the fiber per second (pulse rate) when interrogating fibers with overall lengths exceeding 10 km. As such, utilizing DAS in a subsea environment may have to increase the returned signal strength with given pulse power, increase the maximum pulse power that may be used for given fiber optic cable length, maintain the pulse power as high as possible as it propagates down the fiber optic cable length, and increase the number of light pulses that may be launched into the fiber optic cable per second.

FIG. 21 illustrates an example of a land-based well system 2100, which illustrates a coiled tubing operation. Without limitation, while a coiled tubing operation is shown, a wireline operation and/or the like may be utilized. As illustrated interrogator 124 is attached to information handling system 130. Further discussed below, lead lines may connect umbilical line 126 to interrogator 124. Umbilical line 126 may include a first fiber optic cable 304 and a second fiber optic cable 308 which may be individual lead lines. Without limitation, first fiber optic cable 304 and a second fiber optic cable 308 may attach to coiled tubing 2102 as umbilical line 126. Umbilical line 126 may traverse through wellbore 122 attached to coiled tubing 2102. In examples, coiled tubing 2102 may be spooled within hoist 2104. Hoist 2104 may be used to raise and/or lower coiled tubing 2102 in wellbore 122. Further illustrated in FIG. 21, umbilical line 126 may connect to distal circulator 312, further discussed below. Distal circulator 312 may connect umbilical line 126 to downhole fiber 128.

FIG. 2 illustrates an example of DAS system 200. DAS system 200 may include information handling system 130 that is communicatively coupled to interrogator 124. Without limitation, DAS system 200 may include a single-pulse coherent Rayleigh scattering system with a compensating interferometer. In examples, DAS system 200 may be used for phase-based sensing of events in a wellbore using measurements of coherent Rayleigh backscatter or may interrogate a fiber optic line containing an array of partial reflectors, for example, fiber Bragg gratings.

As illustrated in FIG. 2, interrogator 124 may include a pulse generator 214 coupled to a first coupler 210 using an optical fiber 212. Pulse generator 214 may be a laser, or a laser connected to at least one amplitude modulator, or a laser connected to at least one switching amplifier, i.e., semiconductor optical amplifier (SOA). First coupler 210 may be a traditional fused type fiber optic splitter, a circulator, a PLC fiber optic splitter, or any other type of splitter known to those with ordinary skill in the art. Pulse generator 214 may be coupled to optical gain elements (not shown) to amplify pulses generated therefrom. Example optical gain elements include, but are not limited to, Erbium Doped Fiber Amplifiers (EDFAs) or Semiconductor Optical Amplifiers (SOAs).

DAS system 200 may include an interferometer 202. Without limitations, interferometer 202 may include a Mach-Zehnder interferometer. For example, a Michelson interferometer or any other type of interferometer 202 may also be used without departing from the scope of the present disclosure. Interferometer 202 may include a top interferometer arm 224, a bottom interferometer arm 222, and a gauge 223 positioned on bottom interferometer arm 222. Interferometer 202 may be coupled to first coupler 210 through a second coupler 208 and an optical fiber 232. Interferometer 202 further may be coupled to a photodetector assembly 220 of DAS system 200 through a third coupler 234 opposite second coupler 208. Second coupler 208 and third coupler 234 may be a traditional fused type fiber optic splitter, a PLC fiber optic splitter, or any other type of optical splitter known to those with ordinary skill in the art. Photodetector assembly 220 may include associated optics and signal processing electronics (not shown). Photodetector assembly 220 may be a semiconductor electronic device that uses the photoelectric effect to convert light to electricity. Photodetector assembly 220 may be an avalanche photodiode or a pin photodiode but is not intended to be limited to such.

When operating DAS system 200, pulse generator 214 may generate a first optical pulse 216 which is transmitted through optical fiber 212 to first coupler 210. First coupler 210 may direct first optical pulse 216 through a fiber optical cable 204. It should be noted that fiber optical cable 204 may be included in umbilical line 126 and/or downhole fiber 128 (e.g., FIG. 1). As illustrated, fiber optical cable 204 may be coupled to first coupler 210. As first optical pulse 216 travels through fiber optical cable 204, imperfections in fiber optical cable 204 may cause a portion of the light to be backscattered along fiber optical cable 204 due to Rayleigh scattering. Scattered light according to Rayleigh scattering is returned from every point along fiber optical cable 204 along the length of fiber optical cable 204 and is shown as backscattered light 228 in FIG. 2. This backscatter effect may be referred to as Rayleigh backscatter. Density fluctuations in fiber optical cable 204 may give rise to energy loss due to the scattered light, α_{scat}, with the following coefficient:

$${α}_{s c a t} = \frac{8 {π}^{3}}{3 {λ}^{4}} {n}^{8} {p}^{2} k {T}_{f} β \qquad ( 1 )$$

where n is the refraction index, p is the photoelastic coefficient of fiber optical cable 204, k is the Boltzmann constant, and β is the isothermal compressibility. T_{f} is a fictive temperature, representing the temperature at which the density fluctuations are “frozen” in the material. Fiber optical cable 204 may be terminated with a low reflection device (not shown). In examples, the low reflection device (not shown) may be a fiber coiled and tightly bent to violate Snell's law of total internal reflection such that all the remaining energy is sent out of fiber optical cable 204.

Backscattered light 228 may travel back through fiber optical cable 204, until it reaches second coupler 208. First coupler 210 may be coupled to second coupler 208 on one side by optical fiber 232 such that backscattered light 228 may pass from first coupler 210 to second coupler 208 through optical fiber 232. Second coupler 208 may split backscattered light 228 based on the number of interferometer arms so that one portion of any backscattered light 228 passing through interferometer 202 travels through top interferometer arm 224 and another portion travels through bottom interferometer arm 222. Therefore, second coupler 208 may split the backscattered light from optical fiber 232 into a first backscattered pulse and a second backscattered pulse. The first backscattered pulse may be sent into top interferometer arm 224. The second backscattered pulse may be sent into bottom interferometer arm 222. These two portions may be re-combined at third coupler 234, after they have exited interferometer 202, to form an interferometric signal.

Interferometer 202 may facilitate the generation of the interferometric signal through the relative phase shift variations between the light pulses in top interferometer arm 224 and bottom interferometer arm 222. Specifically, gauge 223 may cause the length of bottom interferometer arm 222 to be longer than the length of top interferometer arm 224. With different lengths between the two arms of interferometer 202, the interferometric signal may include backscattered light from two positions along fiber optical cable 204 such that a phase shift of backscattered light between the two different points along fiber optical cable 204 may be identified in the interferometric signal. The distance between those points L may be half the length of the gauge 223 in the case of a Mach-Zehnder configuration, or equal to the gauge length in a Michelson interferometer configuration.

While DAS system 200 is running, the interferometric signal will typically vary over time. The variations in the interferometric signal may identify strains in fiber optical cable 204 that may be caused, for example, by seismic energy. By using the time of flight for first optical pulse 216, the location of the strain along fiber optical cable 204 and the time at which it occurred may be determined. If fiber optical cable 204 is positioned within a wellbore, the locations of the strains in fiber optical cable 204 may be correlated with depths in the formation in order to associate the seismic energy with locations in the formation and wellbore.

To facilitate the identification of strains in fiber optical cable 204, the interferometric signal may reach photodetector assembly 220, where it may be converted to an electrical signal. The photodetector assembly may provide an electric signal proportional to the square of the sum of the two electric fields from the two arms of the interferometer. This signal is proportional to:

P(t)=P1+P2+2*\sqrt{(P1P2)cos(ϕ1−ϕ2)} (2)

where Pₙ is the power incident to the photodetector from a particular arm (1 or 2) and ϕₙ is the phase of the light from the particular arm of the interferometer. Photodetector assembly 220 may transmit the electrical signal to information handling system 130, which may process the electrical signal to identify strains within fiber optical cable 204 and/or convey the data to a display and/or store it in computer-readable media. Photodetector assembly 220 and information handling system 130 may be communicatively and/or mechanically coupled. Information handling system 130 may also be communicatively or mechanically coupled to pulse generator 214.

Modifications, additions, or omissions may be made to FIG. 2 without departing from the scope of the present disclosure. For example, FIG. 2 shows a particular configuration of components of DAS system 200. However, any suitable configurations of components may be used. For example, pulse generator 214 may generate a multitude of coherent light pulses, optical pulse 216, operating at distinct frequencies that are launched into the sensing fiber either simultaneously or in a staggered fashion. For example, the photo detector assembly is expanded to feature a dedicated photodetector assembly for each light pulse frequency.

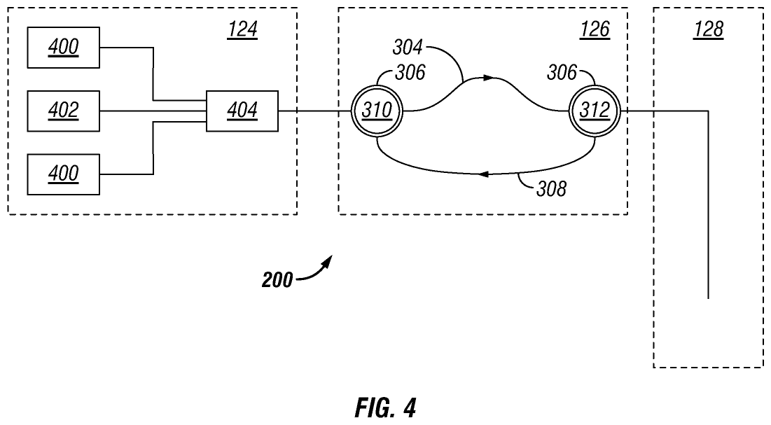

It should be noted that during simultaneous or staggered operation, interrogator units 400 (e.g., referring to FIG. 4) may be programmed in sequence so that light pulses are never in the fiber optic cable at the same time. Additionally, interrogator units 400 may operate at the same time and light pulses from different interrogator units 400 are launched at different times so that the chance of them overlapping within the fiber optic cable is small, which may be defined as asynchronous simultaneous operation or an interleaving operation. Thus, during operations, light pulses from interrogator units 400 may overlap at the launch point (or somewhere during propagation) and cause an interference. As a large number of light pulses are launched, statistically interference is small.

Simultaneous or staggered operation may be performed with high-speed shutters or switches, which may be used to synchronously blank unwanted pulses from entering complementary interrogator units 400 or route specific light pulses to the intended interrogator units 400. Different interrogator units 400 lasers, regardless of operating wavelength, would be synchronized with external high speed optical system switches to alternately use one or more fiber optic cables while interleaving alternating pulses from each interrogator units 400, without using a WDM 404 and associated methods (e.g., referring to FIG. 4). This type of operation may be defined as a Time Division Multiplexing (TDM) of a common transmission line in the traditional sense which may make use of enhanced reflectivity band provided by one or more common FBGs to allow for sharing at 1545 nm without compromising pulse repetition rate from one or more interrogator units 400. If operating wavelengths and spectral linewidths of interrogator units 400 are the same, then velocity and dispersion characteristics would also be closely matched to help prevent pulses from one interrogator unit 400 being switched to the other interrogator units 400.

In examples, a compensating interferometer may be placed in the launch path (i.e., prior to traveling down fiber optical cable 204) of the interrogating pulse to generate a pair of pulses that travel down fiber optical cable 204. In examples, interferometer 202 may not be necessary to interfere the backscattered light from pulses prior to being sent to photo detector assembly. In one branch of the compensation interferometer in the launch path of the interrogating pulse, an extra length of fiber not present in the other branch (a gauge length similar to gauge 223 of FIG. 1) may be used to delay one of the pulses. To accommodate phase detection of backscattered light using DAS system 200, one of the two branches may include an optical frequency shifter (for example, an acousto-optic modulator) to shift the optical frequency of one of the pulses, while the other may include a gauge. This may allow using a single photodetector receiving the backscatter light to determine the relative phase of the backscatter light between two locations by examining the heterodyne beat signal received from the mixing of the light from different optical frequencies of the two interrogation pulses.

In examples, DAS system 200 may generate interferometric signals for analysis by the information handling system 130 without the use of a physical interferometer. For instance, DAS system 200 may direct backscattered light to photodetector assembly 220 without first passing it through any interferometer, such as interferometer 202 of FIG. 2. Alternatively, the backscattered light from the interrogation pulse may be mixed with the light from the laser originally providing the interrogation pulse. Thus, the light from the laser, the interrogation pulse, and the backscattered signal may all be collected by photodetector assembly 220 and then analyzed by information handling system 130. The light from each of these sources may be at the same optical frequency in a homodyne phase demodulation system or may be different optical frequencies in a heterodyne phase demodulator. This method of mixing the backscattered light with a local oscillator allows measuring the phase of the backscattered light along the fiber relative to a reference light source.

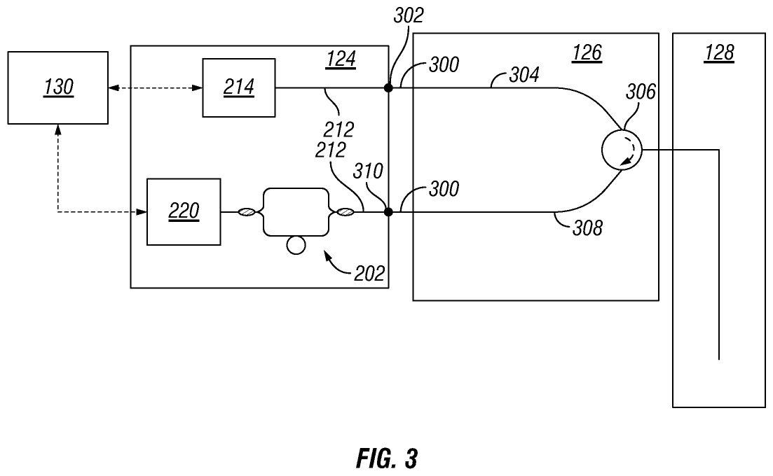

FIG. 3 illustrates an example of DAS system 200, which may be utilized to overcome challenges presented by a subsea environment. DAS system 200 may include interrogator 124, umbilical line 126, and downhole fiber 128. As illustrated, interrogator 124 may include pulse generator 214 and photodetector assembly 220, both of which may be communicatively coupled to information handling system 130. Additionally, interferometers 202 may be placed within interrogator 124 and operate and/or function as described above. FIG. 3 illustrates an example of DAS system 200 in which lead lines 300 may be used. As illustrated, an optical fiber 212 may attach pulse generator 214 to an output 302, which may be a fiber optic connector. Umbilical line 126 may attach to output 302 with a first fiber optic cable 304. First fiber optic cable 304 may traverse the length of umbilical line 126 to a remote circulator 306. Remote circulator 306 may connect first fiber optic cable 304 to second fiber optic cable 308. In examples, remote circulator 306 functions to steer light unidirectionally between one or more input and outputs of remote circulator 306. Without limitation, remote circulators 306 are three-port devices wherein light from a first port is split internally into two independent polarization states and wherein these two polarization states are made to propagate two different paths inside remote circulator 306. These two independent paths allow one or both independent light beams to be rotated in polarization state via the Faraday effect in optical media. Polarization rotation of the light propagating through free space optical elements within the circulator thus allows the total optical power of the two independent beams to uniquely emerge together with the same phase relationship from a second port of remote circulator 306.

Conversely, if any light enters the second port of remote circulator 306 in the reverse direction, the internal free space optical elements within remote circulator 306 may operate identically on the reverse direction light to split it into two polarizations states. After appropriate rotation of polarization states, these reverse in direction polarized light beams, are recombined, as in the forward propagation case, and emerge uniquely from a third port of remote circulator 306 with the same phase relationship and optical power as they had before entering remote circulator 306. Additionally, as discussed below, remote circulator 306 may act as a gateway, which may only allow chosen wavelengths of light to pass through remote circulator 306 and pass to downhole fiber 128. Second fiber optic cable 308 may attach umbilical line 126 to input 311. Input 311 may be a fiber optic connector which may allow backscatter light to pass into interrogator 124 to interferometer 202. Interferometer 202 may operate and function as described above and further pass back scatter light to photodetector assembly 220.

FIG. 4 illustrates another example of DAS system 200. As illustrated, interrogator 124 may include one or more DAS interrogator units 400, each emitting coherent light pulses at a distinct optical wavelength, and a Raman Pump 402 connected to a wavelength division multiplexer 404 (WDM) with fiber stretcher. Without limitation, WDM 404 may include a multiplexer assembly that multiplexes the light received from the one or more DAS interrogator units 400 and a Raman Pump 402 onto a single optical fiber and a demultiplexer assembly that separates the multi-wavelength backscattered light into its individual frequency components and redirects each single wavelength backscattered light stream back to the corresponding DAS interrogator unit 400. In an example, WDM 404 may utilize an optical add-drop multiplexer to enable multiplexing the light received from the one or more DAS interrogator units 400 and a Raman Pump 402 and demultiplexing the multi-wavelength backscattered light received from a single fiber. WDM 404 may also include circuitry to optically amplify the multi-frequency light prior to launching it into the single optical fiber and/or optical circuitry to optically amplify the multi-frequency backscattered light returning from the single optical fiber, thereby compensating for optical losses introduced during optical (de-) multiplexing. Raman Pump 402 may be a co-propagating optical pump based on stimulated Raman scattering, to feed energy from a pump signal to a main pulse from one or more DAS interrogator units 400 as the main pulse propagates down one or more fiber optic cables. This may conservatively yield a 3 dB improvement in SNR. As illustrated, Raman Pump 402 is located in interrogator 124 for co-propagation. In another example, Raman Pump 402 may be located topside after one or more remote circulators 306 either in line with first fiber optic cable 304 (co-propagation mode) and/or in line with second fiber optic cable 308 (counter-propagation). In another example, Raman Pump 402 is marinized and located after distal circulator 312 configured either for co-propagation or counter-propagation. In still another example, the light emitted by the Raman Pump 402 is remotely reflected by using a wavelength-selective filter beyond a remote circulator in order to provide amplification in the return path using a Raman Pump 402 in any of the topside configurations outlined above.

Further illustrated in FIG. 4, WDM 404 with fiber stretcher may attach proximal circulator 310 to umbilical line 126. Umbilical line 126 may include one or more remote circulators 306, a first fiber optic cable 304, and a second fiber optic cable 308. As illustrated, a first fiber optic cable 304 and a second fiber optic cable 308 may be separate and individual fiber optic cables that may be attached at each end to one or more remote circulators 306. In examples, first fiber optic cable 304 and second fiber optic cable 308 may be different lengths or the same length and each may be an ultra-low loss transmission fiber that may have a higher power handling capability before non-literarily. This may enable a higher gain, co-propagation Raman amplification from interrogator 124.

Deploying first fiber optic cable 304 and as second fiber optic cable 308 from floating vessel 102 (e.g., referring to FIG. 1) to a subsea environment to a distal-end passive optical circulator arrangement, enables downhole fiber 128, which is a sensing fiber, to be below a remote circulator 306 (e.g., well-only) that may be at the distal end of DAS system 200. This may allow for higher (2-3×) pulse repetition rates and allow for the optical receivers to be adjusted such that their dynamic range is optimized for downhole fiber 128. This may approximately yield a 3.5 dB improvement in SNR. Additionally, downhole fiber 128 may be a sensing fiber that has higher Rayleigh scattering coefficient (i.e., higher doping) which may result in a ten times improvement in backscatter, which may yield a 7 dB improvement in SNR. In examples, remote circulators 306 may further be categorized as a proximal circulator 310 and a distal circulator 312. Proximal circulator 310 is located closer to interrogator 124 and may be located on floating vessel 102 or within umbilical line 126. Distal circulator 312 may be further away from interrogator 124 than proximal circulator 310 and may be located in umbilical line 126 or within wellbore 122 (e.g., referring to FIG. 1). As discussed above, a configuration illustrated in FIG. 3 may not utilize a proximal circulator 310 with lead lines 300.

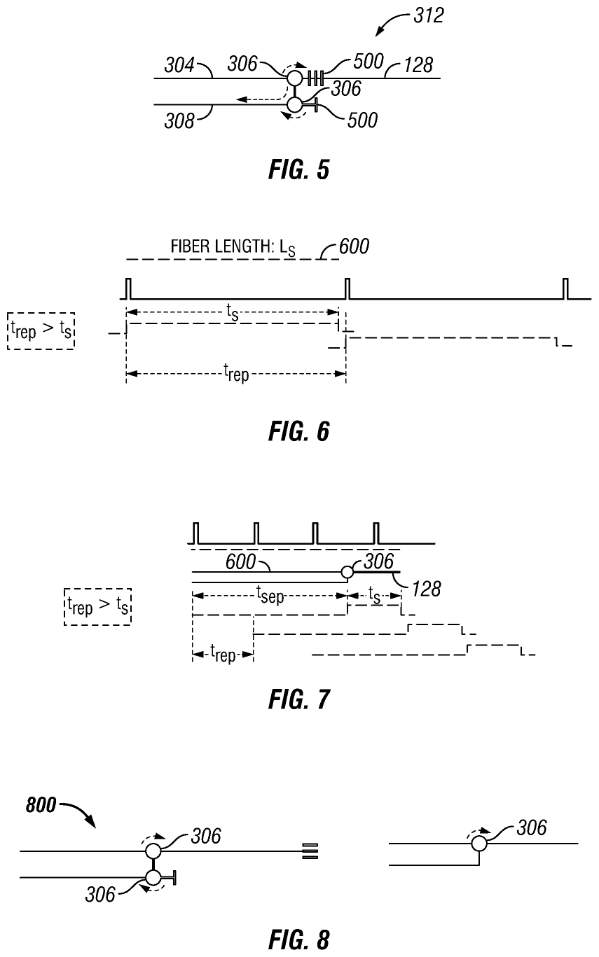

FIG. 5 illustrates another example of distal circulator 312, which may include two remote circulators 306. As illustrated, each remote circulator 306 may function and operate to avoid overlap, at interrogator 124, of backscattered light from two different pulses. For example, during operations, light at a first wavelength may travel from interrogator 124 down first fiber optic cable 304 to a remote circulator 306. As the light passes through remote circulator 306 the light may encounter a Fiber Bragg Grating 500. In examples, Fiber Bragg Grating 500 may be referred to as a filter mirror that may be a wavelength specific high reflectivity filter mirror or filter reflector that may operate and function to recirculate unused light back through the optical circuit for “double-pass” co/counter propagation Raman amplification of the DAS signal at 1550 nm. In examples, this wavelength specific “Raman light” mirror may be a dichroic thin film interference filter, Fiber Bragg Grating 500, or any other suitable optical filter that passes only the 1550 nm forward propagating DAS interrogation pulse light while simultaneously reflecting most of the residual Raman Pump light.

Without limitation, Fiber Bragg Grating 500 may be set-up, fabricated, altered, and/or the like to allow only certain selected wavelengths of light to pass. All other wavelengths may be reflected back to the second remote circulator, which may send the reflected wavelengths of light along second fiber optic cable 308 back to interrogator 124. This may allow Fiber Bragg Grating 500 to split DAS system 200 (e.g., referring to FIG. 4) into two regions. A first region may be identified as the devices and components before Fiber Bragg Grating 500 and the second region may be identified as downhole fiber 128 and any other devices after Fiber Bragg Grating 500.

Splitting DAS system 200 (e.g., referring to FIG. 4) into two separate regions may allow interrogator 124 (e.g., referring to FIG. 1) to pump specifically for an identified region. For example, the disclosed system of FIG. 4 may include one or more Raman pumps 402, as described above, placed in interrogator 124 or after proximal circulator 310 at the topside either in line with first fiber optic cable 304 or second fiber optic cable 308 that may emit a wavelength of light that may travel only to a first region and be reflected by Fiber Bragg Grating 500. A second Raman pump may emit a wavelength of light that may travel to the second region by passing through Fiber Bragg Grating 500. Additionally, both the first Raman pump and second Raman pump may transmit at the same time. Without limitation, there may be any number of Raman pumps and any number of Fiber Bragg Gratings 500 which may be used to control what wavelength of light travels through downhole fiber 128. FIG. 5 also illustrates Fiber Bragg Gratings 500 operating in conjunction with any remote circulator 306, whether it is a distal circulator 312 or a proximal circulator 310. Additionally, as discussed below, Fiber Bragg Gratings 500 may be attached at the distal end of downhole fiber 218. Other alterations to DAS system 200 (e.g., referring to FIG. 4) may be undertaken to improve the overall performance of DAS system 200. For example, the lengths of first fiber optic cable 304 and second fiber optic cable 308 may be selected to increase pulse repetition rate (expressed in terms of the time interval between pulses tᵣₑₚ).

FIG. 6 illustrates an example of fiber optic cable 600 in which no remote circulator 306 may be used. As illustrated, the entire fiber optic cable 600 is a sensor and the pulse interval must be greater than the time for the pulse of light to travel to the end of fiber optic cable 600 and its backscatter to travel back to interrogator 124 (e.g., referring to FIG. 1). This is so, since in DAS systems 200 at no point in time, backscatter from more than one location along sensing fiber (i.e., downhole fiber 128) may be received. Therefore, the pulse interval tᵣₑₚ must be greater than twice the time light takes to travel “one-way” down the fiber. Let tₛ be the “two-way” time for light to travel to the end of fiber optic cable 600 and back, which may be written as tᵣₑₚ>tₛ.

FIG. 7 illustrates an example of fiber optic cable 600 with a remote circulator 306 using the configuration shown in FIG. 3. When a remote circulator 306 is used, only the light traveling in fiber optic cable 600 that is allowed to go beyond remote circulator 306 and to downhole fiber 128 may be returned to interrogator 124 (e.g., referring to FIG. 1), thus, the interval between pulses is dictated only by the length of the sensing portion, downhole fiber 128, of fiber optic cable 600. It should be noted that in terms of pulse timing what matters is the two-way travel time of the light pulse “to” and “from” the sensing portion, downhole fiber 128. Therefore, the first fiber optic cable 304 or second fiber optic cable 308 “to” and “from” remote circulator 306 may be longer than the other, as discussed above.

FIG. 8 illustrates an example remote circulator arrangement 800 which may allow, as described above, configurations that use more than one remote circulator 306 close together at the remote location. Although remote circulator arrangement 800 may have any number of remote circulators 306, remote circulator arrangement 800 may be illustrated as a single remote circulator 306.

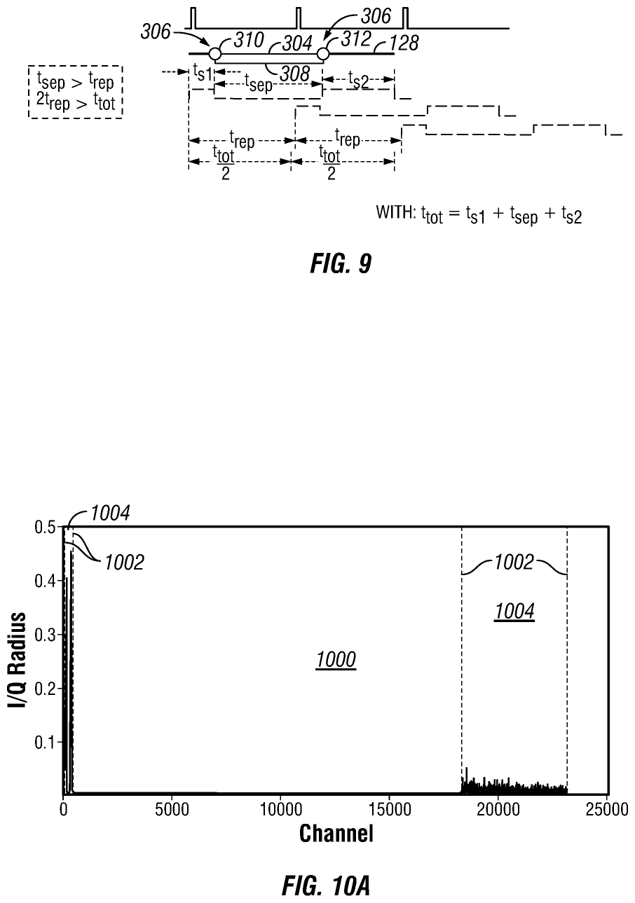

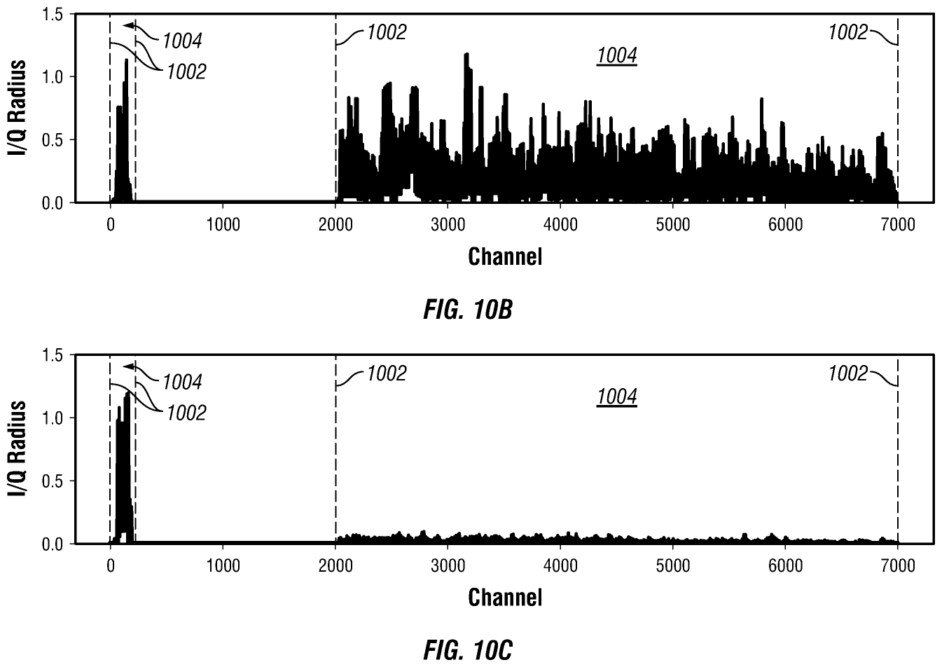

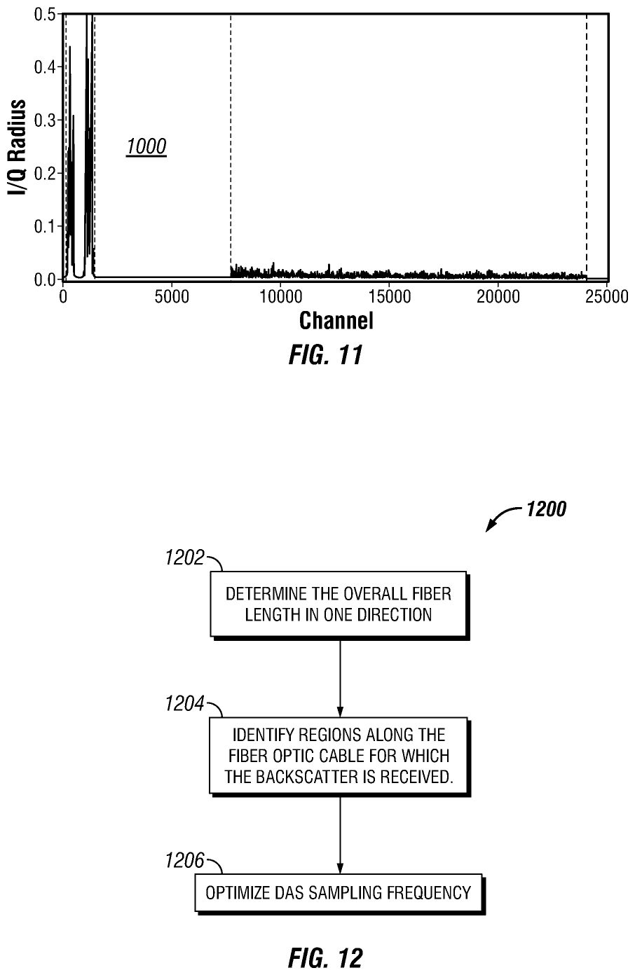

FIG. 9 illustrates an example first fiber optic cable 304 and second fiber optic cable 308 attached to a remote circulator 306 at each end. As discussed above, each remote circulator may be categorized as a proximal circulator 310 and a distal circulator 312. When using a proximal circulator 310 and a distal circulator 312, light from the fiber section before proximal circulator 310, and light from the fiber section below the remote circular 306 are detected, which is illustrated in FIGS. 10 and 11. There is a gap 1000 between them of “no light” that depends on the total length of fiber (summed) between proximal circulator 310 and a distal circulator 312.

Referring back to FIG. 9, with tₛ₁ the duration of the light from fiber sensing section before proximal circulator 310, tₛₑₚ the “dead time” separating the two sections (and due to the cumulative length of first fiber optic cable 304 and second fiber optic cable 308 between proximal circulator 310 and a distal circulator 312), and tₛ₂ the duration of the light from the sensing fiber, downhole fiber 128, beyond distal circulator 312, the constraints on fiber lengths and pulse intervals may be identified as:

i.

tᵣₑₚ<tₛₑₚ (3)

ii.

(2tᵣₑₚ)>(tₛ₁+tₛₑₚ+tₛ₂) (4)

Criterion (i) ensures that “pulse n” light from downhole fiber 128 does not appear while “pulse n+1” light from fiber before proximal circulator 310 is being received at interrogator 124 (e.g., referring to FIG. 1). Criterion (ii) ensures that “pulse n” light from downhole fiber 128 is fully received before “pulse n+2” light from fiber before proximal circulator 310 is being received at interrogator 124. It should be noted that the two criteria given above only define the minimum and maximum tᵣₑₚ for scenarios where two pulses are launched in the fiber before backscattered light below the remote circulator 306 is received. However, it should be appreciated that for those skilled in the art these criteria may be generalized to cases where n∈{1,2,3, } light pulses may be launched in the fiber before backscattered light below the remote circulator 306 is received.

The use of remote circulators 306 may allow for DAS system 200 (e.g., referring to FIG. 3) to increase the sampling frequency. FIG. 12 illustrates workflow 1200 for optimizing sampling frequency when using a remote circulator 306 in DAS system 200. Workflow 1200 may begin with block 1202, which determines the overall fiber length in both directions. For example, in case of a 17 km of first fiber optic cable 304 and 17 km of second fiber optic cable 308 before distal circulator 312 and 8 km of sensing fiber, downhole fiber 128, after distal circulator 312, the overall fiber optic cable length in both directions would be 50 km. Assuming a travel time of the light of 5 ns/m, the following equation may be used to calculate a first DAS sampling frequency fₛ

$${f}_{s} = \frac{1}{{t}_{s}} = \frac{1}{5 \cdot {10}^{- 9} \cdot z} \qquad ( 5 )$$

where tₛ is the DAS sampling interval and z is the overall two-way fiber length. Thus, for an overall two-way fiber length of 50 km the first DAS sampling rate fₛ is 4 kHz. In block 1204 regions of the fiber optic cable are identified for which backscatter is received. For example, this is done by calculating the average optical backscattered energy for each sampling location followed by a simple thresholding scheme. The result of this step is shown in FIG. 10A where boundaries 1002 identify two sensing regions 1004. As illustrated in FIG. 10, optical energy is given as:

I²+Q² (6)

where I and Q correspond to the in-phase (I) and quadrature (Q) components of the backscattered light. In block 1206, the sampling frequency of DAS system 200 is optimized. To optimize the sampling frequency a minimum time interval is found that is between the emission of light pulses such that at no point in time backscattered light arrives back at interrogator 124 (e.g., referring to FIG. 1) that corresponds to more than one spatial location along a sensing portion of the fiber-optic line. Mathematically, this may be defined as follows. Let S be the set of all spatial sample locations x along the fiber for which backscattered light is received. The desired light pulse emission interval tₛ is the smallest one for which the cardinality of the two sets S and {mod(x, tₛ): x∈S} is still identical, which is expressed as:

$${min}_{{t}_{s}} ( {t}_{s} ) s . t . \vert S \vert = \vert \{ mod ( x , {t}_{s} ) : x ∈ S \} \vert \qquad ( 7 )$$

where |·| is the cardinality operator, measuring the number of elements in a set. FIG. 11 shows the result of optimizing the sampling frequency from FIG. 10 with workflow 1200. Here, the DAS sampling frequency may increase from 4 kHz to 12.5 kHz without causing any overlap in backscattered locations, effectively increasing the signal to noise ratio of the underlying acoustic data by more than 5 dB due to the increase in sampling frequency.

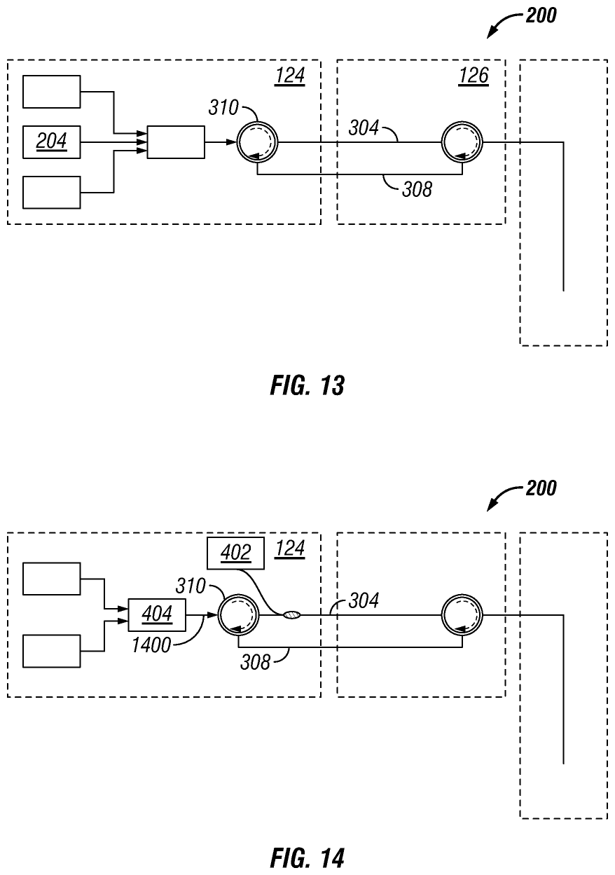

Variants of DAS system 200 may also benefit from workflow 1200. For example, FIG. 13 illustrates DAS system 200 in which proximal circulator 310 is placed within interrogator 124. This system set up of DAS system 200 may allow for system flexibility on how to implement during measurement operations and the efficient placement of Raman Pump 402. As illustrated in FIGS. 13 and 14, first fiber optic cable 304 and second fiber optic cable 308 may connect interrogator 124 to umbilical line 126, which is described in greater detail above in FIG. 3.

FIG. 14 illustrates another example of DAS system 200 in which Raman Pump 402 is operated in co-propagation mode and is attached to first fiber optic cable 304 after proximal circulator 310. For example, if the first sensing region before proximal circulator 310 should not be affected by Raman amplification. Moreover, Raman Pump 402, may also be attached to second fiber optic cable 308 which may allow the Raman Pump 402 to be operated in counter-propagation mode. In examples, the Raman Pump may also be attached to fiber 1400 between WDM 404 and proximal circulator 310 in interrogator 124.

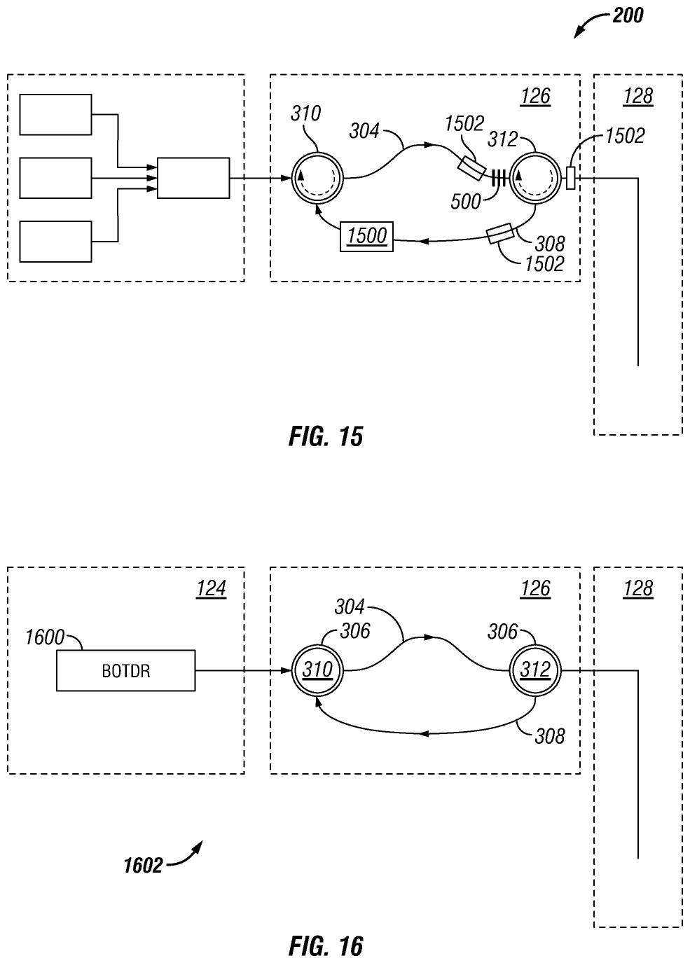

FIG. 15 illustrates another example of DAS system 200 in which an optical amplifier assembly 1500 (i.e., an Erbium doped fiber amplifier (EDFA) +Fabry-Perot filter) may be attached to proximal circulator 310, which may also be identified as a proximal locally pumped optical amplifier. In examples, a distal optical amplifier assembly 1502 may also be attached at distal circulator 312 on first fiber optical cable 304 or second fiber optical cable 308 as an inline or “mid-span” amplifier. In examples, optical amplifier assembly 1502 located in-line with fiber optical cable 304 and above distal circulator 312 may be used to boost the light pulse before it is launched into the downhole fiber 128. Referring to FIGS. 10B and 10C, the effect of using an optical amplifier assembly 1500 in-line with a second fiber optic cable 308 prior to proximal circulator 310 and/or using an distal optical amplifier assembly 1502 located in line with second fiber optical cable 308 above distal circulator 312 may allow for selectively amplifying the backscattered light originating from downhole fiber 128 which tends to suffer from much stronger attenuation as it travels back along downhole fiber 128 and second fiber optical cable 308 than backscattered light originating from shallower sections of fiber optic cable that may also perform sensing functions. FIG. 10B illustrates measurements where proximal circulator 310 is active (optical amplifier assembly 1500 in-line with a second fiber optic cable 308 prior to proximal circulator 310 and/or distal optical amplifier assembly 1502 located in line with second fiber optical cable 308 above distal circulator 312 is used). FIG. 10C illustrates measurements where proximal circulator 310 is passive (no optical amplification is used in-line with second fiber optic cable 308). In FIGS. 10B and 10C, boundaries 1002 identify two sensing regions 1004. Additionally, in FIGS. 10B and 10C the DAS sampling frequency is set to 12.5 kHz using workflow 1200. Further illustrated Fiber Bragg Grating 500 may also be disposed on first fiber optical cable 304 between distal optical amplifier assembly 1502 and distal circulator 312.

During operation, data quality from DAS system 200 (e.g., referring to FIG. 2) may be governed by signal quality and sampling rate. Signal quality is predominantly constrained by the power of backscattered light and sampling rate is constrained by sensing fiber length. For example, the less backscattered light that is received from a sensing fiber, which may be downhole fiber 128 or disposed on downhole fiber 128 (e.g., referring to FIG. 1), the more inferior the quality of the measurement taken by DAS system 200.

FIG. 16 illustrates an example in which interrogator 124 is a Brillouin Optical Time Domain Reflectometry (BOTDR) module 1600, which may be used to form a Distributed Temperature Sensing (DTS) system, a Distributed Strain Sensing System, a Distributed Pressure Sensing System, or a combination thereof. It should be noted that a Brillouin Optical Frequency Domain Reflectometry (BOFDR) module may be utilized with or in place of BOTDR module 1600. As disclosed, a BOFDR module may be utilized in place of BOTDR module 1600 for any examples disclose. As illustrated, a single-ended BOTDR module 1600 may attach to proximal circulator 310 in umbilical line 126. Umbilical line 126 may include one or more remote circulators 306, a first fiber optic cable 304, and a second fiber optic cable 308. As illustrated, a first fiber optic cable 304 and a second fiber optic cable 308 may be separate and individual fiber optic cables that may be attached at each end to one or more remote circulators 306. In examples, first fiber optic cable 304 and second fiber optic cable 308 may be different lengths or the same length and each may be a low loss (LL) or an ultra-low loss (ULL) transmission fiber that may have a higher power handling capability before non-literarily. This may enable a higher gain, co-propagating and/or counter-propagating Raman amplification from interrogator 124.

Deploying first fiber optic cable 304 and as second fiber optic cable 308 from floating vessel 102 (e.g., referring to FIG. 1) to a subsea environment to a distal-end passive optical circulator arrangement, enables downhole fiber 128, which is a sensing fiber, to be below a remote circulator 306 (e.g., well-only) that may be at the distal end of distributed fiber sensing system 1602. In examples, remote circulators 306 may further be categorized as a proximal circulator 310 and a distal circulator 312. Proximal circulator 310 is located closer to interrogator 124, or is a part of interrogator 124 (e.g., as illustrated in FIG. 13), and may be located on floating vessel 102 or within umbilical line 126. Distal circulator 312 may be further away from interrogator 124 than proximal circulator 310 and may be located in umbilical line 126 or within wellbore 122 (e.g., referring to FIG. 1). As discussed above, a configuration illustrated in FIG. 3 may not utilize a proximal circulator 310 with lead lines 300.

The downhole fiber 128, which is a sensing fiber, may be designed, manufactured, and installed to preferentially yield higher than native Rayleigh backscatter within an optical bandwidth. Such sensing fibers may be preferentially installed for improving SNR for distributed acoustic sensing (DAS) of the well. BOTDR module 1600 may be preferentially operated at an optical frequency outside of the enhanced Rayleigh backscatter bandwidth of downhole fiber 128. As the enhanced Rayleigh backscatter bandwidth of downhole fiber 128 may be centered at a wavelength 1545 nm (194.04 THz optical frequency) and may have a wavelength bandwidth of 12 nm, which may allow for a frequency bandwidth of 1.51 THz. Thus, the enhanced Rayleigh backscatter bandwidth on the enhanced Rayleigh backscatter fiber may range from about 193.00 THz to about 195.00 THz.

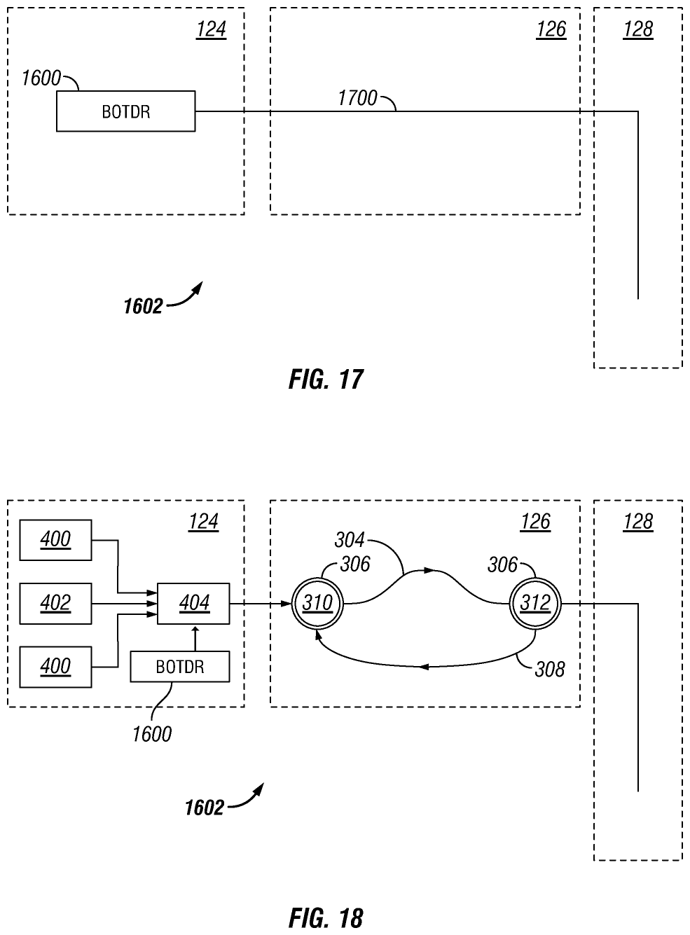

BOTDR module 1600 is a system that may employ methods that use Brillouin backscatter-based strain and temperature measurement technology instead of Raman backscatter, which is discussed above. Additionally, BOTDR module 1600 may have at least a 10 dB greater optical budget than Raman DTS and may be used in previously installed fiber installations that utilize distributed acoustic sensing (DAS) so that existing, as well as new, wells may be interrogated. For example, as illustrated in FIG. 17, BOTDR module 1600 is attached to pre-existing fiber 1700, which may have been previously installed. As illustrated pre-existing fiber 1700 may act as umbilical line 126 and downhole fiber 128, as well as connect to BOTDR module 1600 in interrogator 124. In further examples, pre-existing fiber 1700 may not be pre-existing but may be disposed into a wellbore for measurement operations and may be retrievable. Referring back to FIG. 16, BOTDR module 1600 allows for measurements to be taken to create a temperature profile over the wellbore length at any particular location without requiring the need to run an intervention with slickline, wireline, or coiled tubing, which is not as well thermally connected to the formation and requires settling time for an optical fiber to thermally equilibrate. Additionally, single-point temperature logging tools suffer from the need to run in hole at a reduced rate and suffer from thermal inertia lag, which leads to errors in wellbore temperature profiles.

To measure temperature downhole, a single-ended BOTDR module 1600 interrogates the backscattered time-gated pulses to detect a Brillouin frequency shift, which may be analyzed to determine temperature, strain, pressure, both strain and temperature, or other combination of strain, temperature, or pressure. The BOTDR system may be used to obtain on the Brillouin frequency itself without further interpretation of a measurand, or, by using frequency domain signal selection methods, the temperature and strain signals may be disentangled. Alternatively, an appropriate BOTDR module 1600 that separates the strain and temperature signals within its programming may be used. Alternatively, which is not illustrated, a DBFS may use a second fiber that does not experience strain (e.g., loose tube) to disentangle temperature and strain from the signals. In examples, strain measurements may be reconstructed from measurements taken by the DAS system described above. The DAS system measurements may also be used to aid in disentanglement to determine temperature measurements and strain measurements from recorded signals. The temperature signal may then be used in determining fluid production information within the well, whereas the strain signals may be used to determine health of any fiber optic cable discussed above.

FIG. 18 illustrates another example of distributed fiber sensing system 1602. As illustrated, interrogator 124 may include BOTDR module 1600, one or more DAS interrogator units 400, each emitting coherent light pulses at a distinct optical wavelength, and a Raman Pump 402 connected to a wavelength division multiplexer 404 (WDM). Without limitation, WDM 404 may include a multiplexer assembly that multiplexes the light received from BOTDR module 1600, one or more DAS interrogator units 400, and at least one Raman Pump 402 onto a single optical fiber and a demultiplexer assembly that separates the multi-wavelength backscattered light into its individual frequency components and redirects each single wavelength backscattered light stream back to the corresponding DAS interrogator unit 400. In an example, WDM 404 may utilize an optical add-drop multiplexer to enable multiplexing the light received from the one or more DAS interrogator units 400 and a Raman Pump 402 and demultiplexing the multi-wavelength backscattered light received from a single fiber. WDM 404 may also include circuitry to optically amplify the multi-frequency light prior to launching it into the single optical fiber and/or optical circuitry to optically amplify the multi-frequency backscattered light returning from the single optical fiber, thereby compensating for optical losses introduced during optical (de-)multiplexing. Raman Pump 402 may be a co-propagating and/or counter-propagating optical pump based on stimulated Raman scattering, to feed energy from a pump signal to a main pulse from one or more DAS interrogator units 400 as the main pulse propagates down one or more fiber optic cables. This may conservatively yield a 3 dB improvement in SNR over 20 km tie-backs from well to topside, and a 9 dB improvement in SNR over 50 km tie-backs from well to topside. As illustrated, Raman Pump 402 is located in interrogator 124 for co-propagation. In another example, Raman Pump 402 may be located topside after one or more remote circulators 306 either in line with first fiber optic cable 304 (co-propagation mode) and/or in line with second fiber optic cable 308 (counter-propagation). In another example, Raman Pump 402 is marinized and located before or after distal circulator 312 configured either for co-propagation or counter-propagation. In still another example, the light emitted by the Raman Pump 402 is remotely reflected by using a wavelength-selective filter beyond a remote circulator in order to provide amplification in the return path using a Raman Pump 402 in any of the topside configurations outlined above.

As discussed above, interrogator 124 may include a BOTDR module 1600 and a DAS interrogator unit 400. In examples, both BOTDR module 1600 and a DAS interrogator unit 400 may be connected to umbilical line 126 which is connected to downhole fiber 128. During operations, both BOTDR module 1600 and DAS interrogator unit 400 may operate sequentially using umbilical line 126 and downhole fiber 128. During this operation BOTDR module 1600 may generate and launch a first wavelength into umbilical line 126 and downhole fiber 128. BOTDR module 1600 may then receive a Brillouin backscattered light from a first sensing region and a second sensing region disposed on the downhole fiber 128. Next, DAS interrogator unit 400 may generate and launch the first wavelength into umbilical line 126 and downhole fiber 128. DAS interrogator unit 400 may then receive a Rayleigh backscattered light from the first sensing region and the second sensing region disposed on the downhole fiber. At no point during this operation is DAS interrogator unit 400 and BOTDR module 1600 generating and launching light of any wavelength into umbilical line 126 and downhole fiber 128 at the same time. For this operation, both devices operate separate and apart from each other, but use the same fiber optic cable in umbilical line 126 and downhole fiber 128.

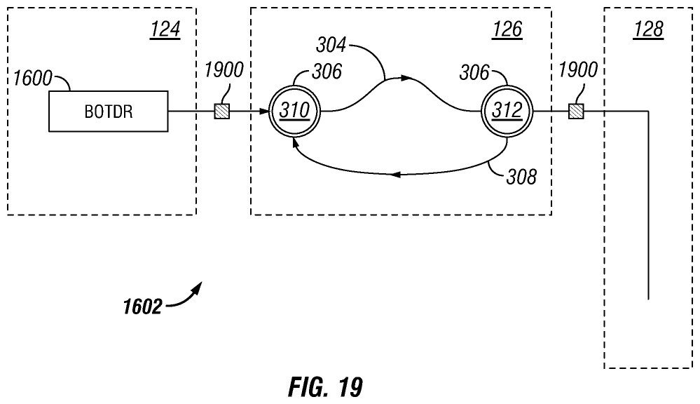

FIG. 19 illustrates an example in which BOTDR Module 1600 may attach to fiber optic rotary joint (FORJ) 1900, which then attaches to downhole fiber 128. FORJ 1900 is a loss-insertion loss device to enable optical continuity across a rotating interface, such as a slickline drum, a wireline drum, or a coiled tubing drum. In examples, FORJ 1900 may be disposed in a Floating Production System (FPSO) turret, which may allow for free rotation of FORJ 1900 in a permanent installation. FORJ 1900 may be incorporated to enable the downhole fiber 128 to sense while temporarily being deployed and while deployed in the well.

Deploying first fiber optic cable 304 and second fiber optic cable 308 from floating vessel 102 (e.g., referring to FIG. 1) to a subsea environment to a distal-end passive optical circulator arrangement, enables downhole fiber 128, which is a sensing fiber, to be below a remote circulator 306 (e.g., well-only) that may be at the distal end of distributed fiber sensing system 1602. In examples, remote circulators 306 may further be categorized as a proximal circulator 310 and a distal circulator 312. Proximal circulator 310 is located closer to interrogator 124, or is a part of interrogator 124 (e.g., as illustrated in FIG. 13), and may be located on floating vessel 102 or within umbilical line 126. Distal circulator 312 may be further away from interrogator 124 than proximal circulator 310 and may be located in umbilical line 126 or within wellbore 122 (e.g., referring to FIG. 1). As discussed above, a configuration illustrated in FIG. 3 may not utilize a proximal circulator 310 with lead lines 300.

Utilizing BOTDR module 1600 in interrogator 124 is an improvement in current technology in that it may provide an intervention-less reservoir monitoring of subsea wells for production monitoring, waterflood or other anomalous fluid production, or providing thermodynamic information of reservoir dynamics. It further improves fiber reliability against catastrophic, unrecoverable, strain-induced glass parting, glass fiber strain health can simultaneously be monitored while making other measurements.

Additional improvements over current technology utilizing BOTDR module 1600 in interrogator 124 may also include a larger measurement length range compared with Raman DTS methods, faster averaging times for the same temperature resolution compared with Raman DTS methods, simultaneously monitoring temperature and strain, which may serve as a back-up or alternative to the existing Rayleigh backscattering based DAS methods. BOTDR module 1600 systems may operate over both single mode and/or multimode optical fibers and provide greater optical signal-to-noise ratio within wellbore from increased interrogator repetition rate.

The systems and methods for a distributed fiber sensing system discussed above, may be implemented within a subsea environment may include any of the various features of the systems and methods disclosed herein, including one or more of the following statements.

Statement 1: A distributed fiber sensing system may comprise an interrogator configured to receive a Brillouin backscattered light from a first sensing region and a second sensing region, first fiber optic cable optically connected to the interrogator, a proximal circulator, and a distal circulator, and a second fiber optic cable optically connected to the interrogator, the proximal circulator, and the distal circulator. The system may further comprise a downhole fiber optically connected to the first fiber optic cable and the second fiber optic cable and wherein the first sensing region and the second sensing region are disposed on the downhole fiber.

Statement 2. The distributed fiber sensing system of statement 1, wherein the downhole fiber is manufactured to have an enhanced Rayleigh backscatter bandwidth within a pre-determined optical bandwidth.

Statement 3. The distributed fiber sensing system of any preceding statements 1 or 2, wherein the interrogator operates at a wavelength outside of the enhanced Rayleigh backscatter bandwidth of the downhole fiber.

Statement 4. The distributed fiber sensing system of any preceding statements 1 or 2, wherein the interrogator further comprises a wavelength division multiplexer (WDM).

Statement 5. The distributed fiber sensing system of statement 4, wherein the interrogator further comprises one or more distributed acoustic sensing (DAS) interrogator units that are connected to the WDM as inputs.

Statement 6. The distributed fiber sensing system of statement 5, wherein the one or more DAS interrogator units operate at a wavelength within an enhanced Rayleigh backscatter bandwidth of the downhole fiber.

Statement 7. The distributed fiber sensing system of any preceding statements 1, 2, or 4, wherein the first fiber optic cable and the second fiber optic cable are different lengths.

Statement 8. The distributed fiber sensing system of any preceding statements 1, 2, 4, or 7, wherein the interrogator further comprises a Raman Pump.

Statement 9. The distributed fiber sensing system of statement 8, wherein the Raman Pump is connected between the proximal circulator and the distal circulator.

Statement 10. The distributed fiber sensing system of any preceding statements 1, 2, 4, 7, or 8, further comprising at least one Fiber Bragg Grating attached to the proximal circulator or the distal circulator.

Statement 11. The distributed fiber sensing system of any preceding statements 1, 2, 4, 7, 8, or 10, wherein the interrogator comprises a Brillouin Optical Time Domain Reflectometry (BOTDR) module or a Brillouin Optical Frequency Domain Reflectometry (BOFDR) module.

Statement 12. The distributed fiber sensing system of any preceding statements 1, 2, 4, 7, 8, 10, or 11, wherein an interrogator receiver arm disposed in the interrogator is configured to receive the Brillouin backscattered light from the first sensing region or the second sensing region.

Statement 13. The distributed fiber sensing system of any preceding statements 1, 2, 4, 7, 8, or 10-12, wherein an optical amplifier assembly is attached to the first fiber optic cable or the second fiber optic cable at the distal circulator.

Statement 14. The distributed fiber sensing system of any preceding statements 1, 2, 4, 7, 8, or 10-13, further comprising at least one Fiber Bragg Grating that is optically attached between the first fiber optic cable and the downhole fiber.

Statement 15. The distributed fiber sensing system of statement 14, wherein the at least one Fiber Bragg Grating is configured for a selected wavelength.

Statement 16. The distributed fiber sensing system of any preceding statements 1, 2, 4, 7, 8, 10-12, or 14, further comprising at least one fiber optic rotary joint (FORJ) disposed between the interrogator and the downhole fiber.

Statement 17. A method for obtaining distributed Brillouin frequency of a fiber in a wellbore may comprise generating and launching a light pulse from an interrogator and through a first fiber optic cable to a downhole fiber and receiving a Brillouin backscattered light from a first sensing region and a second sensing region disposed on the downhole fiber.

Statement 18. The method of statement 17, further comprising calculating a distributed temperature from the Brillouin backscattered light in the first sensing region and the second sensing region.

Statement 19. The method of any preceding statements 17 or 18, further comprising calculating a distributed strain from the Brillouin backscattered light in the first sensing region and the second sensing region.

Statement 20. The method of any preceding statements 17-19, further comprising calculating a distributed pressure from the Brillouin backscattered light in the first sensing region and the second sensing region.

Statement 21. The method of any preceding statements 17-20, further comprising calculating a combination of distributed strain, distributed temperature or distributed pressure from the Brillouin backscattered light in the first sensing region and the second sensing region.

Statement 22. The method of any preceding statements 17-21, wherein the interrogator further comprises a wavelength division multiplexer (WDM) and one or more Distributed Acoustic Sensing (DAS) interrogator units that are connected to the WDM as inputs.

Statement 23. The method of statement 22, further comprising taking a temperature measurement, a strain rate measurement, a vibration measurement, or an acoustic events measurement from a Rayleigh backscattered light in the first sensing region and the second sensing region.

Statement 24. The method of any preceding statements 17-22, wherein the downhole fiber is manufactured to have an enhanced Rayleigh backscatter bandwidth that has a pre-determined optical bandwidth.

Statement 25. The method of statement 24, wherein the interrogator comprises a Brillouin Optical Time Domain Reflectometry (BOTDR) module or a Brillouin Optical Frequency Domain Reflectometry (BOFDR) module that operate at a wavelength outside of the enhanced Rayleigh backscatter bandwidth of the downhole fiber.

Statement 26. The method of any preceding statements 17-22 or 24, wherein the first fiber optic cable and a second fiber optic cable connect to a proximal circulator and a distal circulator.

Statement 27. The method of any preceding statements 17-22, 24, or 26, further comprising at least one fiber optic rotary joint (FORJ) is disposed between the interrogator and the downhole fiber.

Statement 28. A method for operating distributed fiber sensing system may comprise generating and launching a light pulse from an interrogator and through a first fiber optic cable to a downhole fiber, wherein the interrogator comprises a Brillouin Optical Time Domain Reflectometry (BOTDR) module or a Brillouin Optical Frequency Domain Reflectometry (BOFDR) module and a Distributed Acoustic Sensing (DAS) module, receiving a Brillouin backscattered light from a first sensing region and a second sensing region disposed on the downhole fiber, generating and launching a second light pulse from the DAS at a second wavelength, and receiving a Rayleigh backscattered light from the first sensing region and the second sensing region disposed on the downhole fiber.

Although the present disclosure and its advantages have been described in detail, it should be understood that various changes, substitutions and alterations may be made herein without departing from the spirit and scope of the disclosure as defined by the appended claims. The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A distributed fiber sensing system comprising:
an interrogator configured to receive a Brillouin backscattered light from a first sensing region and a second sensing region;
a first fiber optic cable optically connected to the interrogator, a proximal circulator, and a distal circulator;
a second fiber optic cable optically connected to the interrogator, the proximal circulator, and the distal circulator; and
a downhole fiber optically connected to the first fiber optic cable and the second fiber optic cable and wherein the first sensing region and the second sensing region are disposed on the downhole fiber.

2. The distributed fiber sensing system of claim 1, wherein the downhole fiber is manufactured to have an enhanced Rayleigh backscatter bandwidth within a pre-determined optical bandwidth.

3. The distributed fiber sensing system of claim 2, wherein the interrogator operates at a wavelength outside of the enhanced Rayleigh backscatter bandwidth of the downhole fiber.

4. The distributed fiber sensing system of claim 1, wherein the interrogator further comprises a wavelength division multiplexer (WDM).

5. The distributed fiber sensing system of claim 4, wherein the interrogator further comprises one or more distributed acoustic sensing (DAS) interrogator units that are connected to the WDM as inputs.

6. The distributed fiber sensing system of claim 5, wherein the one or more DAS interrogator units operate at a wavelength within an enhanced Rayleigh backscatter bandwidth of the downhole fiber.

7. The distributed fiber sensing system of claim 1, wherein the first fiber optic cable and the second fiber optic cable are different lengths.

8. The distributed fiber sensing system of claim 1, wherein the interrogator further comprises a Raman Pump.

9. The distributed fiber sensing system of claim 8, wherein the Raman Pump is connected between the proximal circulator and the distal circulator.

10. The distributed fiber sensing system of claim 1, further comprising at least one Fiber Bragg Grating attached to the proximal circulator or the distal circulator.

11. The distributed fiber sensing system of claim 1, wherein the interrogator comprises a Brillouin Optical Time Domain Reflectometry (BOTDR) module or a Brillouin Optical Frequency Domain Reflectometry (BOFDR) module.

12. The distributed fiber sensing system of claim 1, wherein an interrogator receiver arm disposed in the interrogator is configured to receive the Brillouin backscattered light from the first sensing region or the second sensing region.

13. The distributed fiber sensing system of claim 1, wherein an optical amplifier assembly is attached to the first fiber optic cable or the second fiber optic cable at the distal circulator.

14. The distributed fiber sensing system of claim 1, further comprising at least one Fiber Bragg Grating that is optically attached between the first fiber optic cable and the downhole fiber.

15. The distributed fiber sensing system of claim 14, wherein the at least one Fiber Bragg Grating is configured for a selected wavelength.

16. The distributed fiber sensing system of claim 1, further comprising at least one fiber optic rotary joint (FORJ) disposed between the interrogator and the downhole fiber.

17. A method for obtaining distributed Brillouin frequency of a fiber in a wellbore comprising:
generating and launching a light pulse from an interrogator and through a first fiber optic cable to a downhole fiber; and
receiving a Brillouin backscattered light from a first sensing region and a second sensing region disposed on the downhole fiber.

18. The method of claim 17, further comprising calculating a distributed temperature from the Brillouin backscattered light in the first sensing region and the second sensing region.

19. The method of claim 17, further comprising calculating a distributed strain from the Brillouin backscattered light in the first sensing region and the second sensing region.

20. The method of claim 17, further comprising calculating a distributed pressure from the Brillouin backscattered light in the first sensing region and the second sensing region.

21. The method of claim 17, further comprising calculating a combination of distributed strain, distributed temperature or distributed pressure from the Brillouin backscattered light in the first sensing region and the second sensing region.

22. The method of claim 17, wherein the interrogator further comprises a wavelength division multiplexer (WDM) and one or more Distributed Acoustic Sensing (DAS) interrogator units that are connected to the WDM as inputs.

23. The method of claim 22, further comprising taking a temperature measurement, a strain rate measurement, a vibration measurement, or an acoustic events measurement from a Rayleigh backscattered light in the first sensing region and the second sensing region.

24. The method of claim 17, wherein the downhole fiber is manufactured to have an enhanced Rayleigh backscatter bandwidth that has a pre-determined optical bandwidth.

25. The method of claim 24, wherein the interrogator comprises a Brillouin Optical Time Domain Reflectometry (BOTDR) module or a Brillouin Optical Frequency Domain Reflectometry (BOFDR) module that operate at a wavelength outside of the enhanced Rayleigh backscatter bandwidth of the downhole fiber.

26. The method of claim 17, wherein the first fiber optic cable and a second fiber optic cable connect to a proximal circulator and a distal circulator.

27. The method of claim 17, further comprising at least one fiber optic rotary joint (FORJ) is disposed between the interrogator and the downhole fiber.

28. A method for operating distributed fiber sensing system comprising:
generating and launching a light pulse from an interrogator and through a first fiber optic cable to a downhole fiber, wherein the interrogator comprises a Brillouin Optical Time Domain Reflectometry (BOTDR) module or a Brillouin Optical Frequency Domain Reflectometry (BOFDR) module and a Distributed Acoustic Sensing (DAS) module;
receiving a Brillouin backscattered light from a first sensing region and a second sensing region disposed on the downhole fiber;
generating and launching a second light pulse from the DAS at a second wavelength; and
receiving a Rayleigh backscattered light from the first sensing region and the second sensing region disposed on the downhole fiber.
